(19) United States
(12) Patent Application Publication
(10) Pub. No.: US 2002/0085098 A1
(43) Pub. Date: Jul. 4, 2002

(54) System and method for efficiently capturing and managing electronic information

(76) Inventors: Takako Miyazaki, New York, NY (US); Eric D. Edwards, San Franciso, CA (US); Steven G. Goldstein, Los Angeles, CA (US)

Correspondence Address: Gregory J. Koerner, Simon & Koerner LLP, Suite B, 10052 Pasadena Avenue, Cupertino, CA, 95014, US

(21) Appl. No.: 09/754,781

(22) Filed: Jan. 4, 2001

(51) Int. Cl. H04N 5/232

(52) U.S. Cl. 348/211; 348/207

(57) ABSTRACT

A system and method for efficiently capturing and managing electronic information utilizes a simplified peripheral device that may be configured to economically capture various types of image-based and non-image based information. The captured information may then be downloaded by a transfer manager to an electronic camera device or other portable electronic device for subsequent data management procedures that may include various information processing procedures using a selectable processing module, and the storage of the processed information into an appropriate storage location by a storage manager for utilization by a system user.

### BACKGROUND SECTION

1. Field of the Invention

This invention relates generally to techniques for managing information, and relates more particularly to a system and method for efficiently capturing and managing electronic information.

2. Description of the Background Art

Implementing efficient methods for capturing and managing information is a significant consideration for designers and manufacturers of contemporary electronic devices. However, effectively capturing and managing information by utilizing electronic devices may create substantial challenges for system designers. For example, enhanced demands for increased device functionality and performance may require more system processing power and require additional hardware resources. An increase in processing or hardware requirements may also result in a corresponding detrimental economic impact due to increased production costs and operational inefficiencies.

Furthermore, enhanced system capability to perform various advanced operations may provide additional benefits to a system user, but may also place increased demands on the control and management of various system components. For example, an enhanced electronic device that effectively captures, processes, and stores digital image data may benefit from an efficient implementation because of the large amount and complexity of the digital data involved.

In certain applications, an electronic device may capture image data corresponding to a selected photographic target. The captured image data may then require various types of processing to optimize the image data before storing the image data into an appropriate storage location for subsequent utilization by a system user.

Due to factors like the growing demands on system functionality, it is apparent that developing new techniques for capturing visual information is a matter of concern for related electronic technologies. Therefore, for all the foregoing reasons, developing effective systems for capturing and managing information remains a significant consideration for designers, manufacturers, and users of contemporary electronic devices.

### SUMMARY

In accordance with the present invention, a system and method are disclosed for efficiently capturing and managing electronic information. Initially, in one embodiment, a simplified peripheral device preferably may perform data capture procedure to obtain selected image-based or non-image information using a data capture module.

The peripheral device may then establish communications with a camera device via various types of input/output interface(s), and then download the captured information to the camera device using a transfer manager. In accordance with the present invention, the transfer manager may initially analyze the downloaded information or other communications from the peripheral device to identify a type of the downloaded information. The transfer manager may then initiate appropriate information management procedures depending upon the type of downloaded information or peripheral device.

Next, a central processing unit in the camera device may preferably execute an appropriate processing module to perform various processing procedures upon the downloaded information. The processing module may preferably be selected depending upon the type of downloaded information or peripheral device.

A storage manager may preferably then store the processed information into an appropriate storage location, depending upon the type of downloaded information. For example, the processed information may be stored into data storage of a local memory in the camera device. Alternately, the processed information may be stored onto various types of removable storage media, sent to a host computer, transmitted across a distributed computer network, or transmitted over a wireless communications system.

Finally, a system user may access and utilize the processed and stored information from the corresponding storage location. In certain embodiments of the present invention, the foregoing procedures for downloading, processing, and storing the captured information may utilize a display manager to generate a user interface upon a viewfinder of the camera device to thereby provide a system user with an interactive means to control various aspects of the foregoing downloading, processing, and storage functions.

In accordance with the present invention, the foregoing simplified peripheral device may be effectively combined with a relatively more complicated and powerful camera device to thereby provide an efficient system for capturing and managing various types of electronic information. The camera device typically may include significant computing and processing power, as well as a variety of data storage options.

System designers and manufacturers may therefore design various simplified and economical versions of the peripheral device with the intention of utilizing the simplified peripheral device in conjunction with a corresponding camera device that includes special functionality for efficiently and effectively managing information and data that is downloaded from an associated peripheral device. The camera device may thus function as a portable data recorder device, in accordance with the present invention. The present invention therefore provides an improved a system and method for efficiently capturing and managing electronic information.

### BRIEF DESCRIPTION OF THE DRAWINGS

FIG. 1 is a block diagram for one embodiment of a camera device, in accordance with the present invention;

FIG. 2 is a block diagram for one embodiment of the capture subsystem of FIG. 1, in accordance with the present invention;

FIG. 3 is a block diagram for one embodiment of the control module of FIG. 1, in accordance with the present invention;

FIG. 4 is a block diagram for one embodiment of the memory of FIG. 3, in accordance with the present invention;

FIG. 5 is a block diagram for one embodiment of the processing manager of FIG. 4, in accordance with the present invention;

FIG. 6 is a block diagram for one embodiment of the I/O interface(s) of FIG. 3, in accordance with the present invention;

FIG. 7 is a block diagram of an exemplary peripheral device, in accordance with the present invention; and

FIG. 8 is a flowchart of method steps for efficiently capturing and managing electronic information, in accordance with one embodiment of the present invention.

### DETAILED DESCRIPTION

The present invention relates to an improvement in data capture and management techniques. The following description is presented to enable one of ordinary skill in the art to make and use the invention and is provided in the context of a patent application and its requirements. Various modifications to the disclosed embodiments will be readily apparent to those skilled in the art and the generic principles herein may be applied to other embodiments. Thus, the present invention is not intended to be limited to the embodiments shown, but is to be accorded the widest scope consistent with the principles and features described herein.

The present invention comprises a system and method for efficiently capturing and managing electronic information, and advantageously utilizes a simplified peripheral device that may be configured to economically capture various types of image-based and non-image based information. The captured information may then be downloaded by a transfer manager to an electronic camera device or other portable electronic device for subsequent data management procedures that may include various information processing procedures using a selectable processing module, and the storage of the processed information into an appropriate storage location by a storage manager for utilization by a system user.

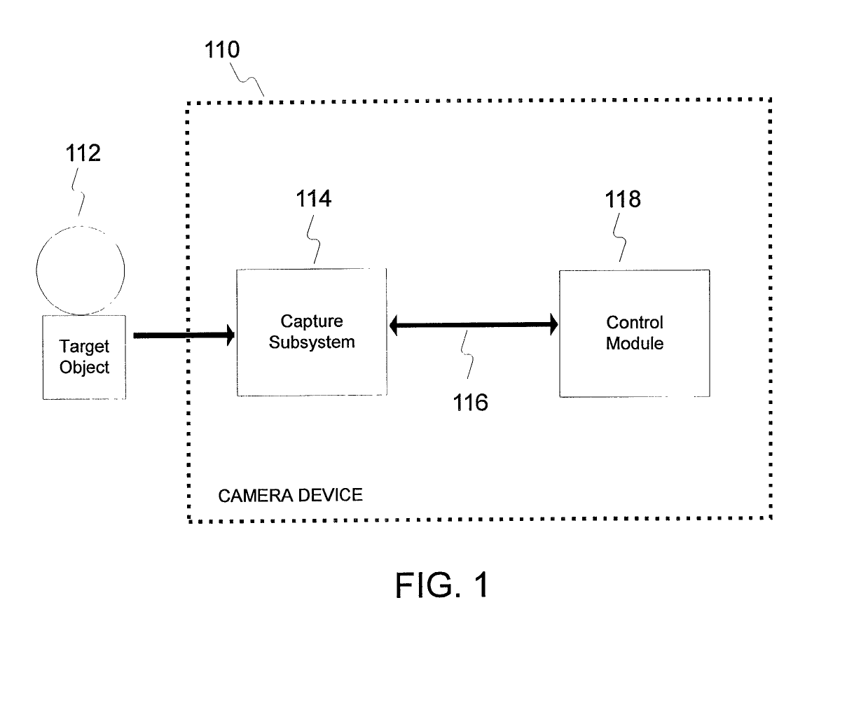

Referring now to FIG. 1, a block diagram for one embodiment of a camera device 110 is shown, in accordance with the present invention. In the FIG. 1 embodiment, camera device 110 may include, but is not limited to, a capture subsystem 114, a system bus 116, and a control module 118. In the FIG. 1 embodiment, capture subsystem 114 may be optically coupled to a target object 112, and may also be electrically coupled via system bus 116 to control module 118.

In alternate embodiments, camera device 110 may readily include various other components in addition to, or instead of, those components discussed in conjunction with the FIG. 1 embodiment. In addition, in certain embodiments, the present invention may alternately be embodied in any appropriate type of electronic device other than the camera device 110 of FIG. 1. For example, camera device 110 may readily be implemented as another type of portable electronic device, such as a hand-held personal digital assistant device.

In the FIG. 1 embodiment, once a system user has focused capture subsystem 114 on target object 112 and requested camera device 110 to capture image data corresponding to target object 112, then control module 118 may preferably instruct capture subsystem 114 via system bus 116 to capture image data representing target object 112. The captured image data may then be transferred over system bus 116 to control module 118, which may responsively perform various processes and functions with the image data. System bus 116 may also bi-directionally pass various status and control signals between capture subsystem 114 and control module 118.

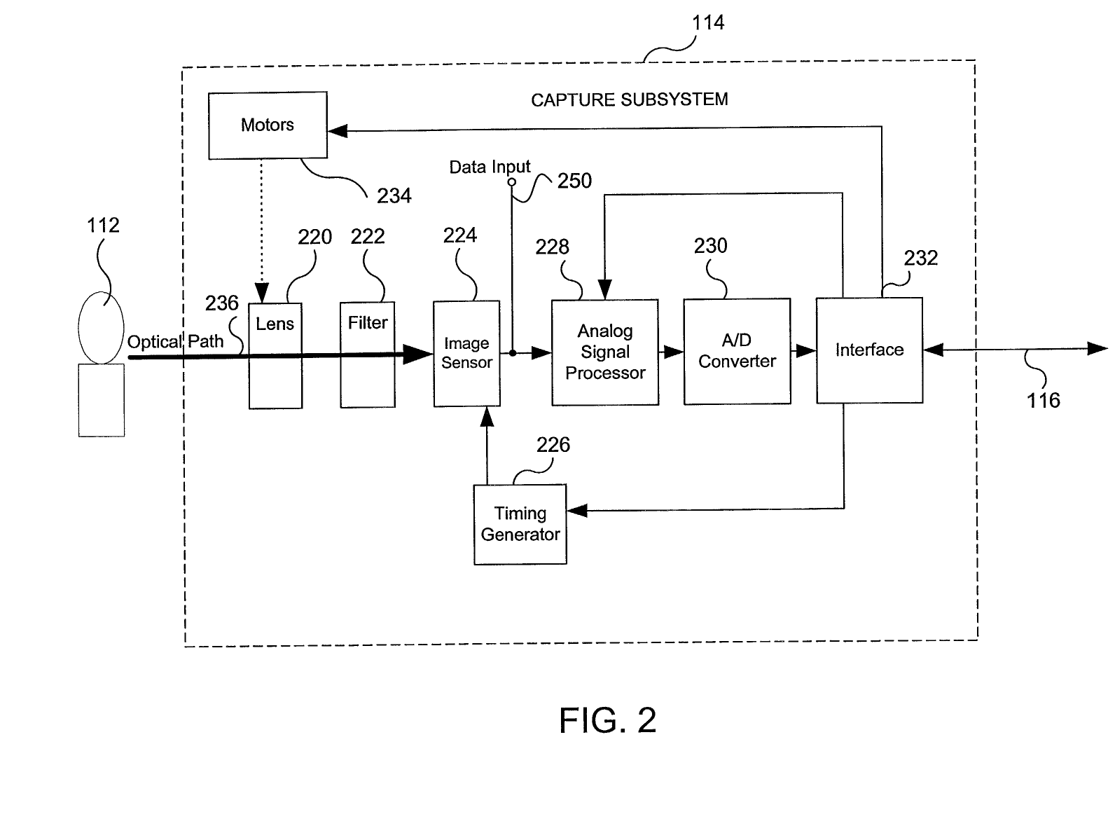

Referring now to FIG. 2, a block diagram for one embodiment of the FIG. 1 capture subsystem 114 is shown, in accordance with the present invention. In the FIG. 2 embodiment, imaging device 114 preferably comprises a lens 220 having an iris (not shown), a filter 222, an image sensor 224, a timing generator 226, an analog signal processor (ASP) 228, an analog-to-digital (A/D) converter 230, an interface 232, a data input 250, and one or more motors 234 to adjust the focus of lens 220. In alternate embodiments, capture subsystem 114 may readily include various other components in addition to, or instead of, those components discussed in conjunction with the FIG. 2 embodiment.

In the FIG. 2 embodiment, capture subsystem 114 may preferably capture image data corresponding to target object 112 via reflected light impacting image sensor 224 along optical path 236. Image sensor 224, which may preferably include a charged-coupled device (CCD), may responsively generate a set of image data representing the target object 112. The image data may then be routed through ASP 228, A/D converter 230, and interface 232. Interface 232 may preferably include separate interfaces for controlling ASP 228, motors 234 and timing generator 226. From interface 232, the image data passes over system bus 116 to control module 118 for appropriate processing and storage.

In the FIG. 2 embodiment, various types of information and data may be provided to camera device 110 via data input 250 for subsequent handling by downstream modules of capture subsystem 114 or control module 118. For example, in certain embodiments, a peripheral device may provide analog data to camera device 110 via data input 250 for subsequent handling, in accordance with the present invention.

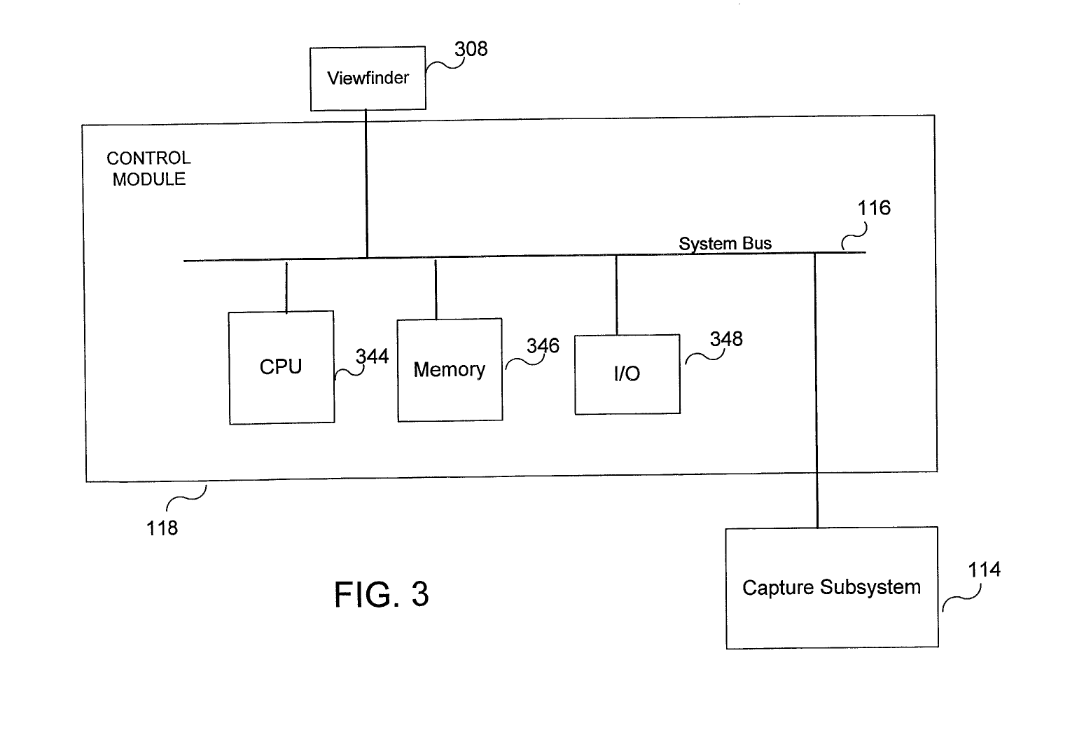

Referring now to FIG. 3, a block diagram for one embodiment of the FIG. 1 control module 118 is shown, in accordance with the present invention. In the FIG. 3 embodiment, control module 118 preferably includes, but is not limited to, a viewfinder 308, a central processing unit (CPU) 344, a memory 346, and one or more input/output interface(s) (I/O) 348. Viewfinder 308, CPU 344, memory 346, and I/O 348 preferably are each coupled to, and communicate, via common system bus 116 that also communicates with capture subsystem 114. In alternate embodiments, control module 118 may readily include various other components in addition to, or instead of, those components discussed in conjunction with the FIG. 3 embodiment.

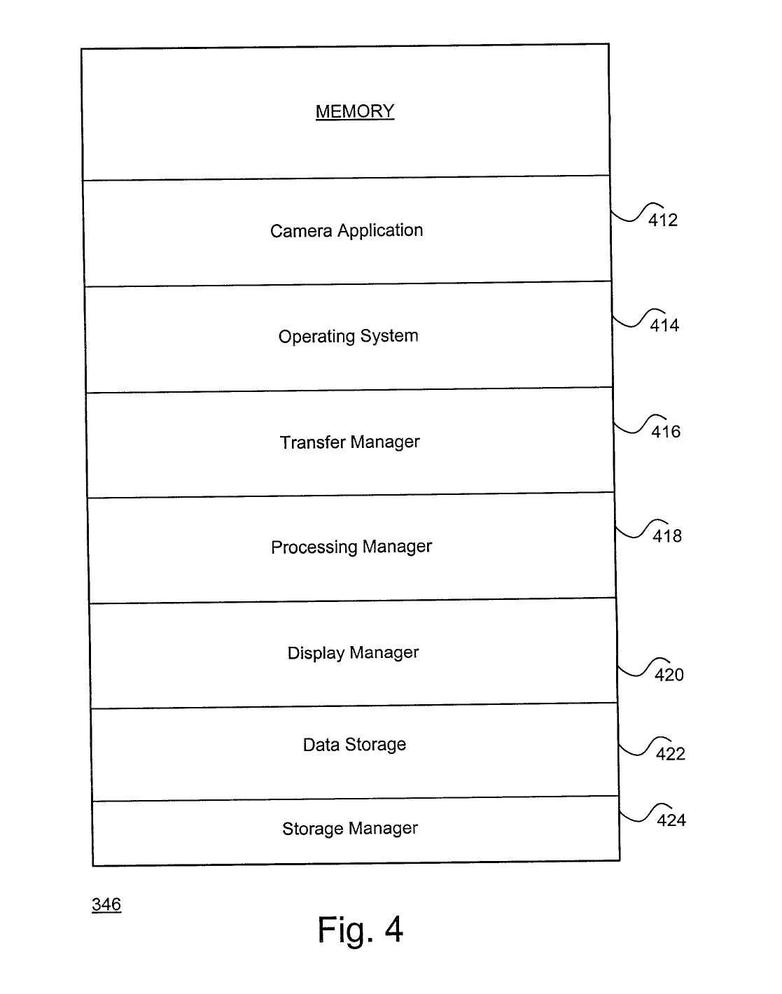

In the FIG. 3 embodiment, CPU 344 may preferably be implemented to include any appropriate microprocessor device. Memory 346 may preferably be implemented as one or more appropriate storage devices, including, but not limited to, read-only memory, random-access memory, and various types of non-volatile memory, such as floppy disc devices, hard disc devices, or flash memory. I/O 348 preferably may provide one or more effective interfaces for facilitating bi-directional communications between camera device 110 and any external entity, including a system user or another electronic device. I/O 348 may be implemented using any appropriate input and/or output devices. The operation and utilization of control module 118 is further discussed below in conjunction with FIGS. 4 through 8.

Referring now to FIG. 4, a block diagram for one embodiment of the FIG. 3 memory 346 is shown, in accordance with the present invention. In the FIG. 4 embodiment, memory 346 preferably includes, but is not limited to, camera application 412, an operating system 414, a transfer manager 416, a processing manager 418, a display manager 420, data storage 422, and a storage manager 424. In alternate embodiments, memory 346 may readily include various other components in addition to, or instead of, those components discussed in conjunction with the FIG. 4 embodiment.

In the FIG. 4 embodiment, camera application 412 may include software instructions that are preferably executed by CPU 344 (FIG. 3) to perform various functions and operations for camera device 110. The particular nature and functionality of camera application 412 preferably varies depending upon factors such as the specific type and particular use of the corresponding camera device 110.

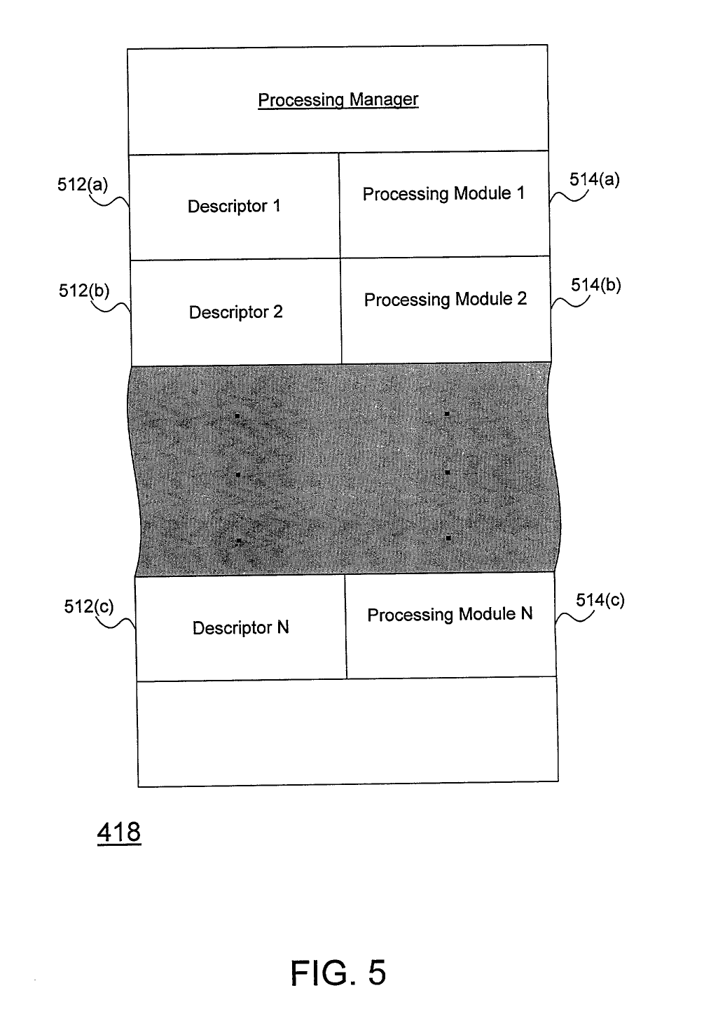

In the FIG. 4 embodiment, operating system 414 preferably controls and coordinates low-level functionality of camera device 110. In accordance with the present invention, transfer manager 416 preferably may control and coordinate an information transfer procedure to download or upload various types of information and data between camera device 110 and various types of peripheral devices and other external entities. Processing manager 418 may preferably process and manipulate the foregoing downloaded information, as further discussed below in conjunction with FIG. 5.

In the FIG. 4 embodiment, display manager 420 preferably may access various types of information and responsively display the information upon viewfinder 308, in accordance with the present invention. Data storage 422 may preferably include individual sets of data that are each provided to control module 118 for processing and storage, as further discussed below in conjunction with FIGS. 5 through 8. Storage manager 424 may preferably store the foregoing downloaded and processed information into an appropriate storage location that typically may be selected depending upon the type of information that is being stored.

Referring now to FIG. 5, a block diagram for one embodiment of the FIG. 4 processing manager 418 is shown, in accordance with the present invention. In alternate embodiments of the present invention, processing manager 418 may readily be implemented to include various other configurations, and may also include various items and components that are different from those discussed in conjunction with the FIG. 5 embodiment.

In the FIG. 5 embodiment, processing manager 418 preferably may include processing module 1 (514(a)) through processing module N (514(c)) that each preferably may be designed to process and handle a certain specific type of downloaded information from a different corresponding peripheral device. In the FIG. 5 embodiment, processing manager 418 preferably also may include a descriptor 1 (512(a)) through a descriptor N (512(c)) that each is preferably associated with a different respective processing module 414. In the FIG. 4 embodiment, descriptors 412 may include any appropriate information for identifying and supplying relevant information regarding a corresponding processing module 414 or type of downloaded information.

In the FIG. 5 embodiment, processing module 1 (514(a)) may be utilized by camera device 110 to perform various processing procedures on image data captured by capture subsystem 114. The remaining processing module 2 (514(b)) through processing module N (514(c)) may each be designed to process a different type of information or data that is downloaded from various peripheral devices. Each processing module 514 preferably may include one or more routines or sub-modules that perform various tasks required for effective processing of associated information or data. For example, an image data processing module 514 may include separate routines for image demosaicing, image sharpening, image compression, and image sizing. Processing modules 514 may utilize existing components of camera device 110, or alternately, camera device 110 may be implemented with additional functionality or components to specifically handle certain designated types of downloaded information.

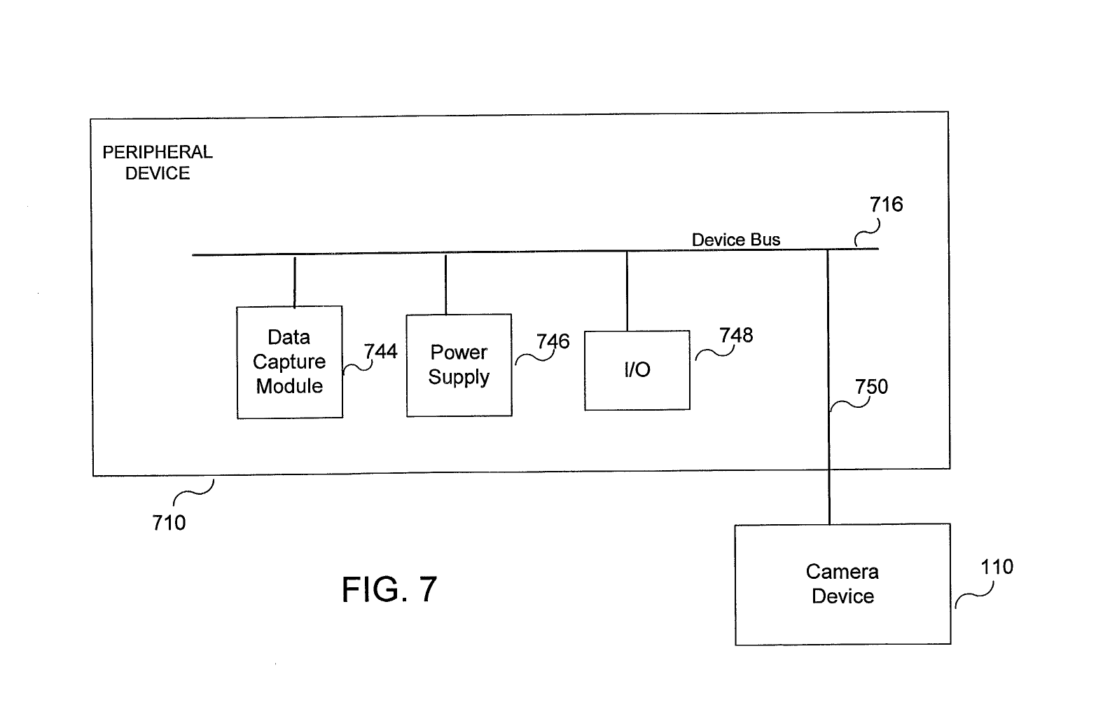

In certain embodiments of the present invention, other software programs in memory 346 may also be configured to include separate modules that each correspond to an associated type of downloaded information from a specified peripheral device. For example, transfer manager 416 and storage manager 424 may each include one or more different modules that are dedicated to handling a specific type of data from a designated type of peripheral device. In addition, in the event that an appropriate type of dedicated software module is not locally available in memory 346, then camera device 110 may advantageously access and download the required software module either wirelessly or through a physical connection from an appropriate source, such as a distributed computer network like the Internet, using I/O interface(s) 348. In certain embodiments, camera device 110 may preferably download the required software module from a peripheral device such as the peripheral device embodiment further discussed below in conjunction with FIG. 7.

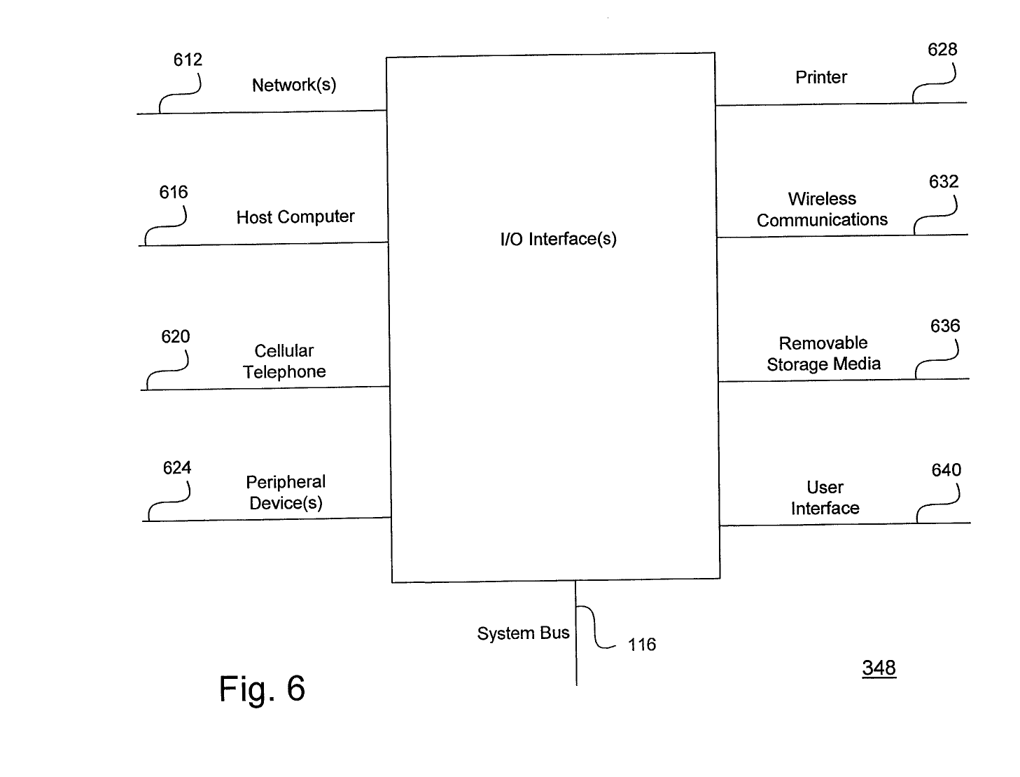

Referring now to FIG. 6, a block diagram for one embodiment of the FIG. 3 I/O interface(s) (I/O) 348 is shown, in accordance with the present invention. In the FIG. 6 embodiment, I/O interface(s) 348 preferably may communicate with various input or output entities that may include, but are not limited to, network(s) 612, a host computer 616, a cellular telephone 620, a printer 628, wireless communications 632, removable storage media 636, and a user interface 640. I/O interface(s) 348 may preferably communicate with camera device 110 via system bus 116. In alternate embodiments, I/O interface(s) 348 may readily include various other elements and functionalities in addition to, or instead of, those discussed in conjunction with the FIG. 6 embodiment. In addition, I/O interface(s) 348 may be implemented and configured using any effective technology or method.

In the FIG. 6 embodiment, camera device 110 may utilize I/O interface(s) 348 to bi-directionally communicate with one or more network(s) 612. For example, camera device 110 may advantageously communicate with the Internet or other distributed computer networks to upload or download various types of information.

Camera device 110 may also utilize I/O interface(s) 348 to bidirectionally communicate with a host computer 616. For example, camera device 110 may communicate with a personal computer device over a Universal Serial Bus (USB) to effectively upload or download various types of information. The foregoing personal computer device may then be utilized to process, manipulate, and otherwise utilize the information from camera device 110. In the FIG. 6 embodiment, camera device 110 may utilize I/O interface(s) 348 to bi-directionally communicate with a cellular telephone 620 to preferably provide any desired information for enabling flexible functionality of camera device 110.

In the FIG. 6 embodiment, camera device 110 may also utilize I/O interface(s) 348 to bi-directionally communicate with various types of wireless communications 632. Wireless communications 632 preferably may include any effective means to remotely communicate with an external entity such as an Internet server, to thereby exchange relevant information for successful operation of camera device 110. In addition, camera device 110 may utilize wireless communications 632 to download various types of information and other data from a wireless source such as a peripheral device. Wireless communications 632 may be implemented using any appropriate wireless technology, including radio-frequency transmission, infra-red transmission, or micro-wave transmission.

In the FIG. 6 embodiment, removable storage media 636 may preferably be utilized to receive or provide any desired information for facilitating the operation of camera device 110. For example, removable storage media 636 may provide means for bi-directional transfers of information between camera device 110 and other appropriate entities, such as a peripheral device. In certain embodiments, removable storage media 636 may include memory devices to support any desired type or combination of removable storage media. For example, removable storage media 636 may include memory sticks, flash memory devices, compact disks, mini-disks, or floppy disks.

In addition to the various foregoing enumerated types of I/O interface(s) 348, camera device 110 preferably may also include any required types of interfaces or connectors (not shown) for coupling camera device 110 and other peripheral devices to support bi-directional electronic communications.

In the FIG. 6 embodiment, user interface 640 preferably may include any effective means to allow a system user to communicate with camera device 110. For example, user interface 640 may support a keyboard device, a wireless remote control device, a speech-recognition module with corresponding microphone, a graphical user interface with touch-screen capability, or a selection button array mounted externally on camera device 110.

Referring now to FIG. 7, a block diagram of an exemplary peripheral device 710 is shown, in accordance with the present invention. In the FIG. 7 embodiment, peripheral device 710 may include, but is not limited to, a data capture module 744, a power supply 746, and a peripheral input/output interface (I/O) 748. In the FIG. 7 embodiment, capture module 744, power supply 746, and input/output interface 748 each preferably may be coupled to a common device bus 716. The FIG. 7 embodiment of peripheral device 710 is presented for purposes of illustration, however, in alternate embodiments of the present invention, peripheral device 710 may readily be implemented to include various other configurations, and may also include various items and components that are different from those discussed in conjunction with the FIG. 7 embodiment.

In the FIG. 7 embodiment, peripheral device 710 may be implemented as any desired type of data capture device. For example, peripheral device 710 may be implemented as a imaging device, such as a scanner, a video recorder, or a bar code reader, that captures image data and then transfers the captured image data to camera device 110 for processing and storage. Alternately, peripheral device 710 may be implemented as a data capture device that that captures non-image data, and then transfers the captured non-image data to camera device 110 for processing and storage. Examples of a non-imaging data capture device may include environmental sensors, audio devices, medical devices, shock sensors, or any other type of data capture device or system.

In the FIG. 7 embodiment, peripheral device 710 may utilize data capture module 744 to capture any desired type of information or data, depending upon the particular function of peripheral device 710. Data capture module 744 may include any required components that are needed to successfully capture the foregoing information or data. For example, data capture device 744 may be a simple active or passive sensor device, or alternately may include a processor device, a memory device, and peripheral software instructions for controlling peripheral device 710.

In the FIG. 7 embodiment, power supply 746 may be included to supply operating power when necessary for the operation of peripheral device 710. I/O 748 preferably may include any appropriate means for allowing peripheral device to communicate with external entities, such as camera device 748 or a system user. For example, I/O 748 may include a physical connector that may be coupled with a corresponding connector on camera device 110 to provide bidirectional communications. Alternately, device bus 716 of peripheral device 710 may communicate directly with camera device 110 via cable connection 750.

In accordance with the present invention, a simplified peripheral device 710 may be effectively combined with a relatively more complicated and powerful camera device 110 to thereby provide an efficient system for capturing and/or managing various types of electronic information. As previously discussed, camera device 110 typically may include substantial computing and processing capabilities, as well as a variety of data storage options. Portable electronic devices, such as camera 110, are also typically in widespread use and therefore easily accessible in most situations.

System designers and manufacturers may therefore design various simplified and economical versions of peripheral device 710 with the intention of utilizing the simplified peripheral device 710 in conjunction with a corresponding camera device 110 that includes special functionality for efficiently managing information and data downloaded from an associated peripheral device 710. Camera device 110 may thus function as a portable data recorder device, in accordance with the present invention.

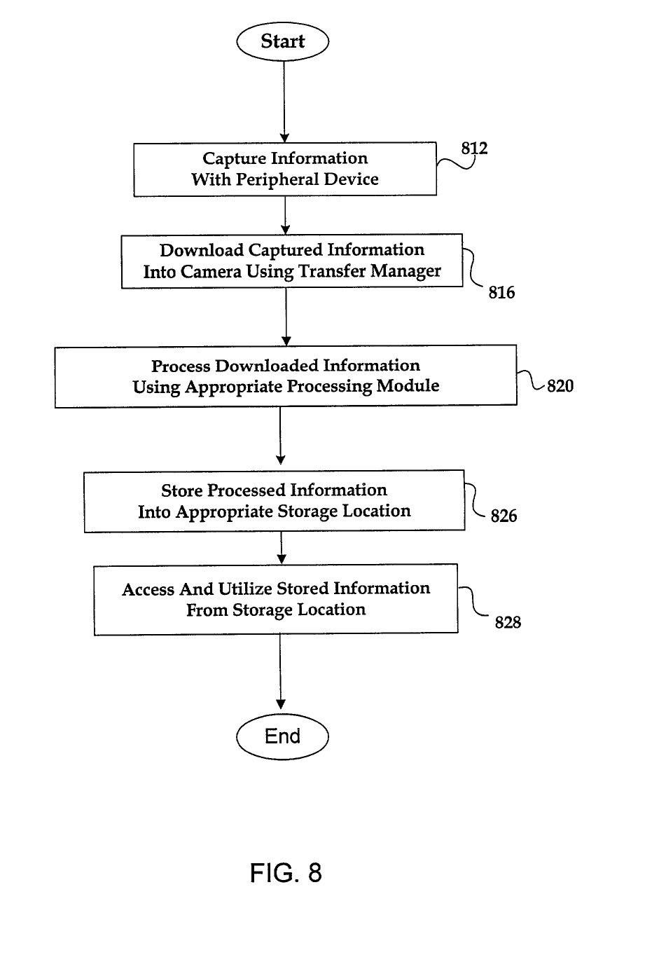

Referring now to FIG. 8, a flowchart of method steps for efficiently capturing and managing electronic information is shown, in accordance with one embodiment of the present invention. The FIG. 8 embodiment is presented for purposes of illustration, and, in alternate embodiments, the present invention may readily utilize various other steps and sequences than those discussed in conjunction with the FIG. 8 embodiment.

In the FIG. 8 embodiment, in step 812, a peripheral device 710 preferably may initially capture selected information or data using a data capture module 744. As discussed above in conjunction with FIG. 7, data capture module 744 may be implemented in any effective manner. However, in accordance with the present invention, a simplified peripheral device 710 may be economically utilized by downloading captured information to camera device 110, and then performing much or all of the data processing and storage functions in camera device 110.

In step 816, the foregoing peripheral device 710 may establish communications with camera device 110 via input/output interface(s) 348, and then download the captured information into camera device 110 using a transfer manager 416. In accordance with the present invention, transfer manager 816 may initially analyze downloaded the information or other communications from peripheral device 710 to thereby identify the type and source of the downloaded information. Transfer manager 816 may then initiate appropriate information management procedures depending upon the type of downloaded information or peripheral device 710.

In step 820, depending upon the type of downloaded information or peripheral device 710, CPU 344 of camera device 110 preferably executes an appropriate processing module 514 to perform various processing procedures upon the downloaded information, as discussed above in conjunction with FIG. 5. In step 826, a storage manager 424 preferably may then store the processed information into an appropriate storage location, depending upon the type of downloaded information. For example, the processed information may be stored into data storage 422 of memory 346. Alternately, the processed information may be stored onto removable storage media 636, sent to host computer 616, transmitted across network(s) 612 or by wireless communications 632.

Finally, in step 828, a system user may then access and utilize the processed and stored information from the corresponding storage location. In certain embodiments of the present invention, the foregoing procedures for downloading, processing, and storing the captured information may readily utilize a display manager 420 to generate a user interface 640 upon viewfinder 308 or other display devices to thereby provide a system user with an interactive means to control various aspects of the foregoing downloading, processing, and storage functions.

The FIG. 8 method steps are discussed in the context of a single peripheral device 710 that provides a single download of captured information to camera device 110. However, utilization of camera device 110 to flexibly manage different types of information from a plurality of different types of peripheral devices is readily contemplated by the present invention,

The invention has been explained above with reference to certain embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A system for managing information, comprising:
a peripheral device configured to selectively capture said information; and
a control device configured to receive said information from said peripheral device, said control device responsively processing and storing said information.

2. The system of claim 1 wherein said information includes at least one of image data and non-image data.

3. The system of claim 1 wherein said peripheral device comprises at least one of an imaging data capture device and a non-imaging data capture device, said imaging data capture device including one of a scanner, a video camera, a barcode reader, and an image sensor device, said non-imaging data capture device including one of a computer, an environmental measurement device, an audio device, a medical device, and a sensor device.

4. The system of claim 1 wherein said peripheral device includes at least one of a data capture module, a power supply, and an input/output interface.

5. The system of claim 1 wherein said control device is implemented as a camera device.

6. The system of claim 5 wherein said camera device includes at least one of a capture subsystem, a viewfinder, and a control module.

7. The system of claim 6 wherein said control module includes at least one of a central processing unit, a memory, and one or more input/output interfaces.

8. The system of claim 7 wherein said memory includes at least one of a camera application, an operating system, a transfer manager, a processing manager, a display manager, data storage, and a storage manager.

9. The system of claim 8 wherein said processing manager includes one or more processing modules, said processing modules each being designed to process and manipulate a different type of said information that is downloaded from a different type of said peripheral device.

10. The system of claim 9 wherein at least one of said processing modules includes at least one of a demosaicing routine, a sharpening routine, a compression routine, a sizing routine, and an image processing routine.

11. The system of claim 7 wherein said input/output interfaces allow said camera device to communicate with at least one of a distributed computer network, a host computer, a cellular telephone, said peripheral device, an Internet network, a printer device, a wireless communications system, a removable storage media device, and a user interface.

12. The system of claim 7 wherein said peripheral device generates captured information by selectively capturing said information with a simplified data capture module that is economically designed, and that does not include substantial data manipulation capabilities.

13. The system of claim 12 wherein a transfer manager in said camera device coordinates a download procedure to download said captured information to said camera device.

14. The system of claim 13 wherein said transfer manager analyzes said captured information from said peripheral device to perform an identification procedure for determining an information type corresponding to said captured information, said transfer manager responsively taking an appropriate action for handling said captured information depending upon said information type.

15. The system of claim 14 wherein an appropriate processing module from a processing manager is selected by said camera device, based upon said information type, and is then executed by a central processing unit in said camera device to thereby generate processed information from said captured information.

16. The system of claim 15 wherein said appropriate processing module is downloaded from an external source through said input/output interfaces by said camera device when said appropriate processing module is not locally available on said camera device, said external source including one of a distributed computer network, a wireless communications system, and an Internet network.

17. The system of claim 15 wherein a storage manager in said camera device accesses and stores said processed information into an appropriate storage location that depends upon an information type of said processed information, said appropriate storage location including at least one of a local memory device in said camera device, a removable storage media device, a mass storage device on a host computer, a network device, and a wireless communications device.

18. The system of claim 17 wherein at least one of said transfer manager and said storage manager includes one or more sub-modules, said submodules each being designed to handle a different type of said information that is downloaded from a different type of said peripheral device.

19. The system of claim 1 wherein said peripheral device is implemented with a minimal configuration to thereby reduce manufacturing costs of said peripheral device.

20. The system of claim 19 wherein said control device is a portable electronic data-recorder device that includes sufficient computing capabilities to effectively process, store, and manage said information instead of utilizing said peripheral device to process, store, and manage said information.

21. A method for managing information, comprising the steps of:
capturing said information with a peripheral device;
receiving said information from said peripheral device by utilizing a control device;
processing said information by selectively utilizing said control device; and
storing said information by utilizing said control device.

22. The method of claim 21 wherein said information includes at least one of image data and non-image data.

23. The method of claim 21 wherein said peripheral device comprises at least one of an imaging data capture device and a non-imaging data capture device, said imaging data capture device including one of a scanner, a video camera, a barcode reader, and an image sensor device, said non-imaging data capture device including one of a computer, an environmental measurement device, an audio device, a medical device, and a sensor device.

24. The method of claim 21 wherein said peripheral device includes at least one of a data capture module, a power supply, and an input/output interface.

25. The method of claim 21 wherein said control device is implemented as a camera device.

26. The method of claim 25 wherein said camera device includes at least one of a capture subsystem, a viewfinder, and a control module.

27. The method of claim 26 wherein said control module includes at least one of a central processing unit, a memory, and one or more input/output interfaces.

28. The method of claim 27 wherein said memory includes at least one of a camera application, an operating system, a transfer manager, a processing manager, a display manager, data storage, and a storage manager.

29. The method of claim 28 wherein said processing manager includes one or more processing modules, said processing modules each being designed to process and manipulate a different type of said information that is downloaded from a different type of said peripheral device.

30. The method of claim 29 wherein at least one of said processing modules includes at least one of a demosaicing routine, a sharpening routine, a compression routine, a sizing routine, and an image processing routine.

31. The method of claim 27 wherein said input/output interfaces allow said camera device to communicate with at least one of a distributed computer network, a host computer, a cellular telephone, said peripheral device, an Internet network, a printer device, a wireless communications system, a removable storage media device, and a user interface.

32. The method of claim 27 wherein said peripheral device generates captured information by selectively capturing said information with a simplified data capture module that is economically designed, and that does not include substantial data manipulation capabilities.

33. The method of claim 32 wherein a transfer manager in said camera device coordinates a download procedure to download said captured information to said camera device.

34. The method of claim 33 wherein said transfer manager analyzes said captured information from said peripheral device to perform an identification procedure for determining an information type corresponding to said captured information, said transfer manager responsively taking an appropriate action for handling said captured information depending upon said information type.

35. The method of claim 34 wherein an appropriate processing module from a processing manager is selected by said camera device, based upon said information type, and is then executed by a central processing unit in said camera device to thereby generate processed information from said captured information.

36. The method of claim 35 wherein said appropriate processing module is downloaded from an external source through said input/output interfaces by said camera device when said appropriate processing module is not locally available on said camera device, said external source including one of a distributed computer network, a wireless communications system, said peripheral device, and an Internet network.

37. The method of claim 35 wherein a storage manager in said camera device accesses and stores said processed information into an appropriate storage location that depends upon an information type of said processed information, said appropriate storage location including at least one of a local memory device in said camera device, a removable storage media device, a mass storage device on a host computer, a network device, and a wireless communications device.

38. The method of claim 37 wherein at least one of said transfer manager and said storage manager includes one or more sub-modules, said sub-modules each being designed to handle a different type of said information that is downloaded from a different type of said peripheral device.

39. The method of claim 21 wherein said peripheral device is implemented with a minimal configuration to thereby reduce manufacturing costs of said peripheral device.

40. The method of claim 39 wherein said control device is a portable electronic data-recorder device that includes sufficient computing capabilities to effectively process, store, and manage said information instead of utilizing said peripheral device to process, store, and manage said information.

41. The method of claim 21 wherein a capture subsystem initially receives said information from said peripheral device through a data input that provides said information to one or more downstream data handling modules from at least one of said capture subsystem and said control device, said information including at least one of analog information and digital information.

42. A computer-readable medium comprising program instructions for managing electronic information by performing the steps of:
capturing said information with a peripheral device;
receiving said information from said peripheral device by utilizing a control device;
processing said information by selectively utilizing said control device; and
storing said information by utilizing said control device.

43. A system for managing information, comprising:
means for capturing said information;
means for accessing said information from said means for capturing;
means for processing said information; and
means for storing said information.
